(19) United States
(12) Patent Application Publication
(10) Pub. No.: US 2007/0192287 A1
(43) Pub. Date: Aug. 16, 2007

(54) METHOD AND SYSTEM FOR PROVIDING OBJECTS WITH EXTENDABLE ATTIBUTES

(76) Inventors: Thomas M. Rothwein, San Jose, CA (US); Haiying Huang, Sunnyvale, CA (US)

Correspondence Address: CSA LLP, 4807 SPICEWOOD SPRINGS RD., BLDG. 4, SUITE 201, AUSTIN, TX, 78759, US

(21) Appl. No.: 09/851,278

(22) Filed: May 8, 2001

(51) Int. Cl. G06F 17/30

(52) U.S. Cl. 707/3

(57) ABSTRACT

A hierarchical class architecture of objects is disclosed. The hierarchical class architecture includes an upper level class, a lower level class and an attribute. The attribute is assigned to the upper level class and describes the objects. The objects are members of at least one of the upper level class and the lower level class. The lower level class is configured to inherit the attribute.

### BACKGROUND OF THE INVENTION

1. Field of the Invention

This invention relates to a method and architecture that allows for the dynamic growth of and for the extension of the attributes that describe objects.

2. Description of the Related Art

An object is a programmatic construct that can be used to describe a product, a person, a document, and other items. Object records define a specific object in detail. For each object, an object record exists. The typical object record can contain descriptive category headings, termed fields or attributes. For each attribute, a set number of values are made possible; the set number of values are the domain of the attribute. For example, for the attribute “color,” the domain of values can be “blue, white, and red.” In the case of personal computers, an attribute for “microprocessor speed” can exist, with the domain for “microprocessor speed” being “greater than 250 megahertz (MHz),” thus excluding speeds below 250 MHz and remaining open ended for speeds greater than 250 MHz.

As users find a need to know more information about objects, there is an increase in the need to have more descriptive attributes. Table 1 illustrates an example of an object record table. This particular object record table is typical of records in databases and other architectures that store object information.

TABLE 1

| Object | Attribute 1 | Attribute 2 | Attribute 3 | Attribute 4 |
|---|---|---|---|---|
| Item 1 | 500 | | 3 | |
| Item 2 | 400 | | 1 | |
| Item 3 | | Blue | 2 | |
| . . . | | Silver | 4 | |
| . . . | | Red | | M |
| Item N | | White | | L |

In Table 1, a list of items is illustrated. The items can include goods, services, people or other data. Items can be similar or dissimilar from one another. In this particular example four attributes exist: “Attribute 1,” “Attribute 2,” “Attribute 3,” and “Attribute 4.” Some of the items are described by certain attributes, although certain attributes do not apply to particular items. In the case of Item 3, “Attribute 2” and “Attribute 3” are applicable; Item 3 is “Blue” and has an “Attribute 3” value of “2.” “Attribute 1” and “Attribute 4” do not apply to Item 3, and so the entries for these attributes are left blank for Item 3's record.

If one desires to provide greater information regarding the Objects of Table 1, additional attributes must be added. Attributes are added subsequent to “Attribute 4.” With each attribute added, a new column is introduced into the table. The new attributes can or can not apply to existing items. The new attributes can be needed to introduce a new set of dissimilar items to the table. If an attribute does not apply to an item, the attribute entries are left empty for the individual object record.

As new items are introduced, for example when a business expands its product line, there is the need to add products to the table, and if the products require specific attributes to accurately describe them, these new attributes and new attribute columns must be added.

With the addition of new, dissimilar items that add new attributes which are not applicable to pre-existing items, more unused (blank) entries are created in the table. The blank entries are a waste of resources, resources that could be used to store actual information. Additional waste of resources takes place when the number of records is increased.

A record table such as Table 1 typically is maintained by a single entity (e.g. a central database manager). That person, group, or company has the discretion to add additional attribute columns. That entity also has the responsibility to determine how to properly allocate resources when resources are limited. In other words, the entity determines whether there is an ability to add additional columns, given the limited storage capacity, and then prioritize columns and attributes to be added. Further, there is the concern of adding new attributes that affect existing item records. For example, a new attribute can be introduced that conflicts with an existing attribute. The entity decides what descriptive attributes are important and which are not. Entities that have the ability add new items are limited in their ability to describe the items, by the existing attributes that are in place.

Therefore, there is the need to provide a method and architecture that makes minimizes or eliminates wasteful use of empty attribute or field entries, and also allows different parties to add additional descriptive attributes to a record without wasting resources or affecting other entries.

### SUMMARY OF THE INVENTION

What is needed and is disclosed herein is an invention that provides for a method and an architecture that arranges objects in a class hierarchy structure. Objects can be members or associated with a particular class. A class can have attributes where child or lower level classes inherit the attributes from parent and higher level classes, for example.

In certain embodiments, attributes are defined by a domain which describes a set of values that describes the attribute. The domain value set can be modified in subsequent lower classes with the lower level classes further modifying the domain of the parent or higher level classes.

In certain embodiments, the class hierarchy can be extended horizontally, allowing classes to be added to an existing class level or levels. In other instances, embodiments provide for vertical expansion, adding new child classes to classes that were considered the lowest existing class.

In one embodiment of the present invention, a hierarchical class architecture of objects is disclosed. The hierarchical class architecture includes an upper level class, a lower level class and an attribute. The attribute is assigned to the upper level class and describes the objects. The objects are members of at least one of the upper level class and the lower level class. The lower level class is configured to inherit the attribute.

In another embodiment of the present invention, a method of arranging objects is disclosed. The method includes setting a class hierarchy (which includes an upper level class and a lower level class), assigning an attribute to the top level class and inheriting of the attribute by the lower level class. The objects are members of at least one of the upper level class and the lower level class, and the attribute describes the objects.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and it's numerous objects, features and advantages made apparent to those skilled in the art by referencing the accompanying drawings. The use of the same reference number throughout the figures designates a like or similar element.

FIG. 1 illustrates an exemplary class hierarchy that describes vehicles.

FIG. 2A illustrates a generic class hierarchy architecture.

FIG. 2B illustrates expanding a class hierarchy architecture and adding a new class hierarchy.

FIG. 3 illustrates a block diagram relationship of objects to classes and attributes.

FIG. 4 is a flowchart illustrating setting up a class hierarchy architecture and assigning members to the classes.

FIG. 5 is a block diagram illustrating a network environment in which commercial transaction processing according to embodiments of the present invention may be practiced.

FIG. 6 is a block diagram illustrating a computer system suitable for implementing embodiments of the present invention.

FIG. 7 is a block diagram illustrating the interconnection of the computer system of FIG. 6 to client and host systems.

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the scope of the present invention as defined by the appended claims.

### DETAILED DESCRIPTION

Objects can be arranged in different classes with a hierarchical system that starts with a general description or general class, and progresses down with sub-classes that provide more specific details of certain objects.

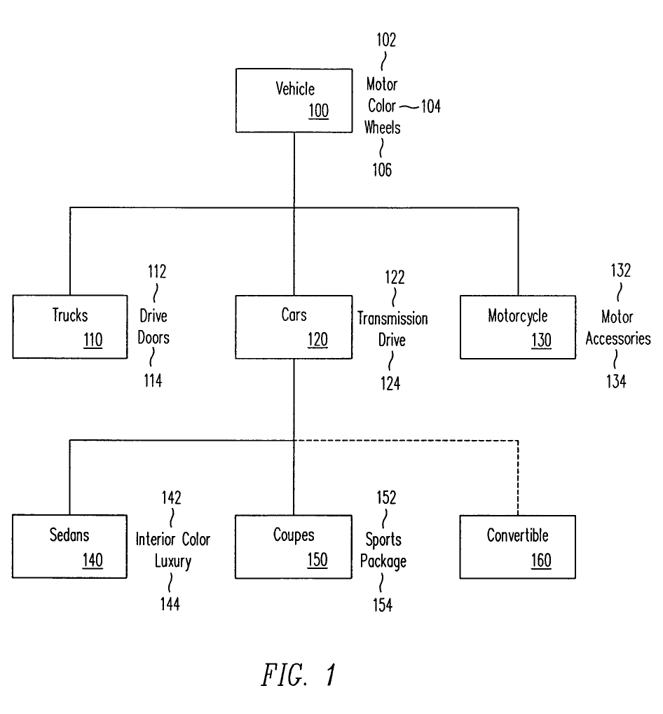

FIG. 1 is a block diagram illustrating an example class hierarchy that describes vehicles. A class vehicle 100 is the most general class of the hierarchy. Below vehicle 100 are classes trucks 110, cars 120, and motorcycles 130. Subclasses to cars 120 are classes sedans 140 and coupes 150. For each class, a set of attributes exists. For example, in class vehicle 100, attributes motor 102, color 104, and wheels 106 are made available. For attribute motor 102, a domain value set can be available that includes “V-8, Turbo 4, Inline 6.” For attribute color 104, the domain can include “silver, black, white.” For attribute wheels 106, the domain can include “12 inch, 13 inch, 14 inch, 15 inch.”

The lower classes of truck 110, cars 120 and motorcycles 130 all have motors, a color and wheels, and so can inherit the attributes of motor 102, color 104, and wheels 106 from the higher level class vehicle 100. Classes trucks 110, cars 120, and motorcycles 130 can also have specific attributes that are unique to objects contained in their classes. Class trucks 110 can have different items that have four-wheel drive or two-wheel drive, and therefore an attribute of drive 112 is added to class trucks 110. In addition, trucks can come with two doors or four doors, so an attribute of doors 114 is added to class trucks 110. An item in class trucks 110 can be described by motor 102, color 104, and wheels 106, attributes that are inherited from class vehicle 100. In addition, class trucks 110 has attributes drive 112 and doors 114 that describe individual items in class trucks 110.

Likewise, class cars 120 can have an attribute transmission 122 and attribute drive 124. Attribute transmission 112 can describe either by an automatic or a standard transmission. Attribute drive 124 can be similar to attribute drive 112, describing whether the drive is four-wheel or two-wheel drive. Since class trucks 110 and class cars 120 both share common attributes, it is possible to use another class between class vehicle 100 and classes trucks 110 and cars 120.

Class motorcycles 130 is a sub-class of class vehicle 100, however, items in class motorcycles 130 may have unique characteristics that conflict with attributes that are inherited from class vehicle 100. For example, although classes trucks 110 and cars 120 can have the same domain of attribute motor 102, items in class motorcycles 130 may not be available with the same domain value set. In other words, motorcycles may not be available with the following motors: V-8, Turbo 4, and Inline 6, motors that are part of the domain value set in attribute motor 102. Therefore, a different motor attribute (motor attribute 132) is given to class motorcycles 130. Attribute motor 132 supercedes attribute motor 102 that was inherited from class vehicle 100. In addition, an attribute accessories 134 is added to class motorcycles 130.

Additional classes can exist below other classes, which further categorize and define items. Below class cars 120 are classes sedans 140 and coupes 150. A class both contains and describes individual items. For a car that is in the class sedans 140, a certain interior color may be available, and an attribute interior color 142 is thus provided. Class sedans 140 can be further defined by whether they are luxury or economy sedans, and an attribute luxury 144 is provided to describe this characteristic. In class coupes 150, coupes can be further defined by an attribute sports 152 that designates a high end sports coupe or an economy coupe. Additionally, there can be an attribute package 154 that provides additional information regarding the value packages that are available.

Additional classes can also be added to the class hierarchy. A manufacturer or supplier of vehicles that uses the class hierarchy of FIG. 1 may decide to add convertibles to its product line. Convertibles may have unique or different attributes that separate them from coupes and sedans. A new class convertibles 160 can be added, which inherits attributes from class cars 120.

Items, and their item records, can exist at or relate to any class level. For example, if it is sufficient to describe a vehicle as being blue, with 13 inch wheels, and a inline 6 motor, that item can be a member of the class vehicle 100. The attributes needed to describe this item include motor 102, color 104, and wheels 106. If desired, the item can be a member of a class further down the hierarchy. For example, to further describe the example in which the vehicle that is blue, with 13 inch wheels, and an inline 6 motor, the vehicle can be a member of the class sedans 140. The vehicle can be further described with an automatic transmission from attribute transmission 122, with two wheel drive from attribute drive 124, with a blue interior from attribute interior color 142, and an economy edition from attribute luxury 144.

An item, to have the attributes necessary to describe the item, associates itself with a particular class. In the preceding example, when the item is a member of the general class of vehicle 100, the item record appears as in Table 3. The object is identified as an item ABC. ABC can be the model number or other reference number related to the particular item.

TABLE 3

| | Class | | | |
|---|---|---|---|---|
| Object | Vehicle | Motor | Color | Wheels |
| ABC | | Inline 6 | Blue | 13 inch |

When item 123 is related to the more definitive class sedans 140, the item record for item 123 appears as in Table 4.

TABLE 4

| | Class | | | | | | | |
|---|---|---|---|---|---|---|---|---|
| Object | Sedans | Motor | Color | Wheels | Transmission | Drive | Interior | Luxury |
| ABC | | Inline 6 | Blue | 13 inch | Automatic | 2 wheel | Blue | Economy |

To further illustrate the inheritance of attributes from higher level classes, the example classes and the attributes that exist for the particular class are described in Table 5.

TABLE 5

| Class | Parent Class | | | | | | | |
|---|---|---|---|---|---|---|---|---|
| Vehicle | None | Motor | Color | Wheels | | | | |
| Trucks | Vehicle | Motor | Color | Wheels | Doors | Drive | | |
| Cars | Vehicles | Motor | Color | Wheels | Transmission | Drive | | |
| Sedans | Cars | Motor | Color | Wheels | Transmission | Drive | Int. Color | Luxury |
| Coupes | Cars | Motor | Color | Wheels | Transmission | Drive | Sports | Package |
| Motorcycle | Vehicles | Motor | Color | Wheels | Motor | Access. | | |

An item, to be properly described (in as much or as little detail as required) associates itself to a particular class. Association to the class provides the appropriate number of attributes to the particular item. Items (or object records describing items) therefore use only the required number of entries. No blank entries exist as a result of items having attributes that are not relevant to that item.

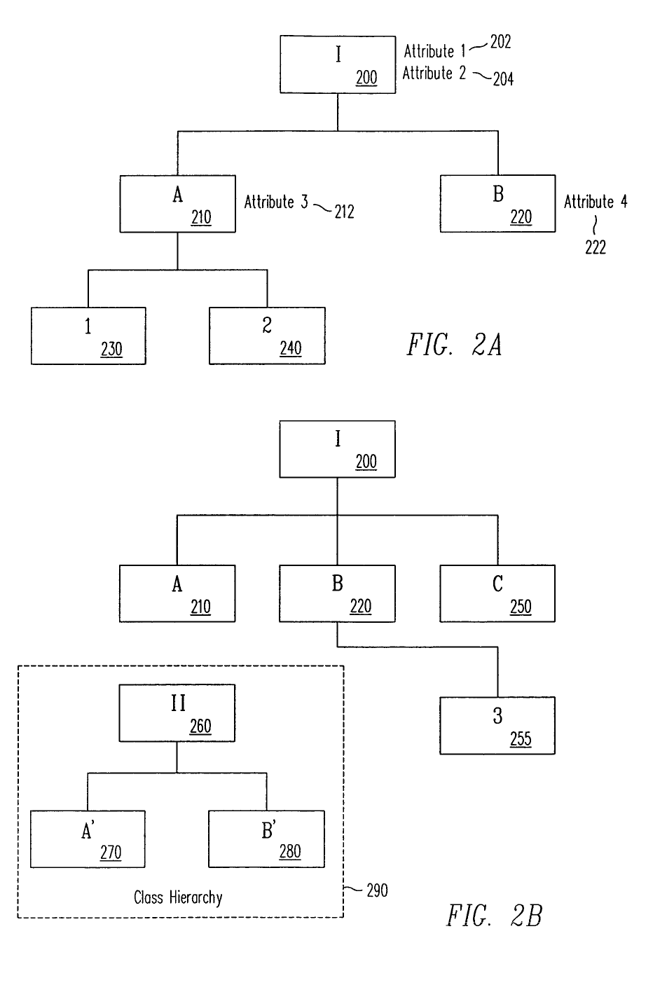

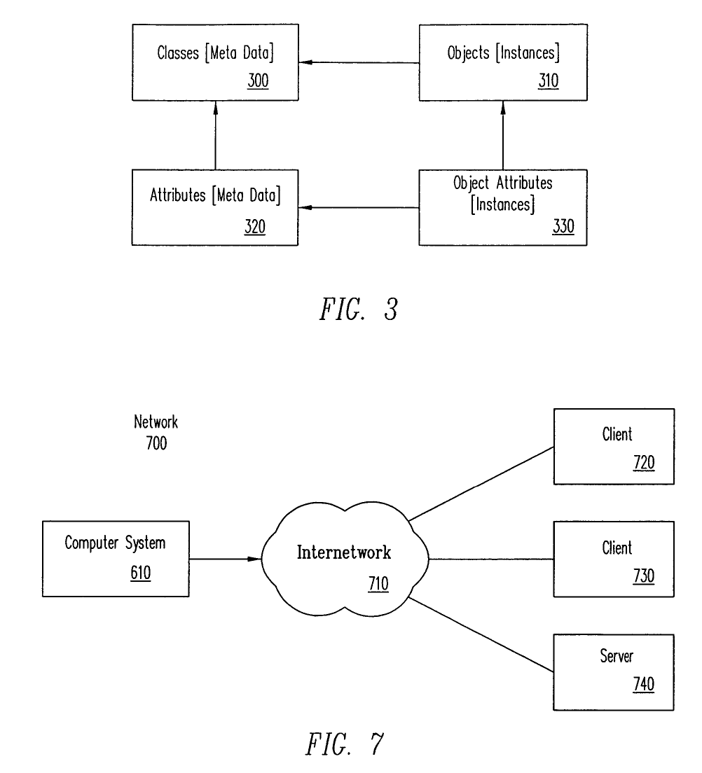

FIG. 2A is a block diagram illustrating a generic hierarchical class architecture. Higher level classes can be referred to as parent classes, and lower level classes as children classes. In FIG. 2, class I 200 is a parent class to class A 210 and class B 220. Class A 210 is both a parent class and a child class. Class A 210 is a parent class of class 1 230 and class 2 240; as well as being a child class of class I 200. Class 1 230 and class 2 240 are child classes of class A 210. Additional classes can be added by various entities. Table 6 illustrates a class relationship.

TABLE 6

| Name | Parent Class | Child Class |
|---|---|---|
| Class I | | Class A, Class B |
| Class A | Class I | Class 1, Class 2 |
| Class B | Class I | |
| Class 1 | Class A | |
| Class 2 | Class A | |

FIG. 2B is a block diagram illustrating an expansion of a class hierarchy. The class hierarchy can be expanded horizontally by adding classes, such as a class C 250. Additions to this class can be made by various entities, without the need for a single central entity to determine the effects upon existing objects or item records. The class hierarchy can also be expanded vertically, as illustrated by the addition of a class 3 255. When an entirely new class of items or objects is created, for example when a manufacturer or supplier provides branche dissimilar goods or services, a separate class hierarchy is created. This is illustrated by a new class hierarchy, class hierarchy 290, a top level class 260, and child classes A'270 and B'280.

Attributes associated with each class can be inherited from the parent class, the attributes can be new attributes in the class, or the attributes can be overriding attributes as described in the previous example regarding vehicles. Table 7 illustrates certain attribute relationships.

TABLE 7

| Name | Class | Domain |
|---|---|---|
| Attribute 1 | Class I | [Red, Green, Blue] |
| Attribute 2 | Class I | [100-500] |
| Attribute 1 | Class A | [Red, Green] |
| Attribute 2 | Class A | [100-500] |
| Attribute 3 | Class A | [Hard top \| Soft top] |
| Attribute 2 | Class B | [100-200] |
| Attribute 1 | Class B | [Red, Green, Blue] |

Class I 200 includes an Attribute 1 202 and an Attribute 204. The domain of Attribute 1 is “red, green, and blue.” Class A 210 inherits Attribute 1 from class I. Class A, however, overrides the domain value set of Attribute 1 by restricting the domain to the color choice of “red and green.” Class A 210 further inherits Attribute 2 204, however, the domain remains the same with values from 100-200. Class B 220 also inherits Attribute 1 from class I; however, class B modifies the domain set to values 100-200. Class A 210 further adds a new Attribute 3 212 with a domain value set of “Hard top or Soft top.” A child class cannot remove an inherited attribute from a parent class, but can make the domain more specific or restrictive. For example, within the class convertibles 160, only the colors blue and green are available, although the attribute colors 104 has been inherited that includes the domain “red, green, and blue.”

In embodiments of the invention, metadata relationships will be seen to exist. Metadata is data about data, and describes a particular set of data and how the data is used or formatted. In embodiments of the preferred invention, if a child class is identified, the parent class is also identified. A child class inherits the attributes that exist in the parent class and may also add unique attributes. Since attributes also are unique and descriptive, like classes, they are considered metadata. Identifying an attribute identifies the class and classes associated with the attribute. Multiple classes can be related to the attribute, since the attribute can be inherited from parent classes.

As discussed in the previous example of vehicles, an object or item is associated with a particular class. The class association provides the number of attributes that are available to describe the particular item. Table 8 illustrates object and class association.

TABLE 8

| Object | Class Type |
|---|---|
| Item 1 | Class I |
| Item 2 | Class A |
| Item 3 | Class B |
| . . . | . . . |
| Item N | . . . |

The items are treated as specific instances in relation to the classes. This is an open-ended list, so additional object records can be added as illustrated by the record of indefinite item N in Table 8.

Further object item definition is illustrated in Table 9, which provides an association of an item to a particular attribute, and provides a value from the domain of the attribute. Table 9 further illustrates how storage resources are efficiently used, with no blank entries.

TABLE 9

| Object | Attribute | Value |
|---|---|---|
| Item 1 | Attribute 1 | Blue |
| Item 1 | Attribute 2 | 250 |
| Item 2 | Attribute 1 | Green |
| Item 2 | Attribute 2 | 200 |
| Item 2 | Attribute 3 | Hard Top |
| . . . | | |

FIG. 3 is a block diagram illustrating relationships between objects and classes, and attributes. Objects 310, with a class identification relate, to classes 300. Classes 300 as previously discussed, are metadata that describe other data content, in particular attributes. Object attributes 330 relate both to specific objects 310 and attributes 320. Attributes 320 also are considered metadata, with the ability to describe other data, in particular associations with classes. Attributes 320 directly relate to classes 300.

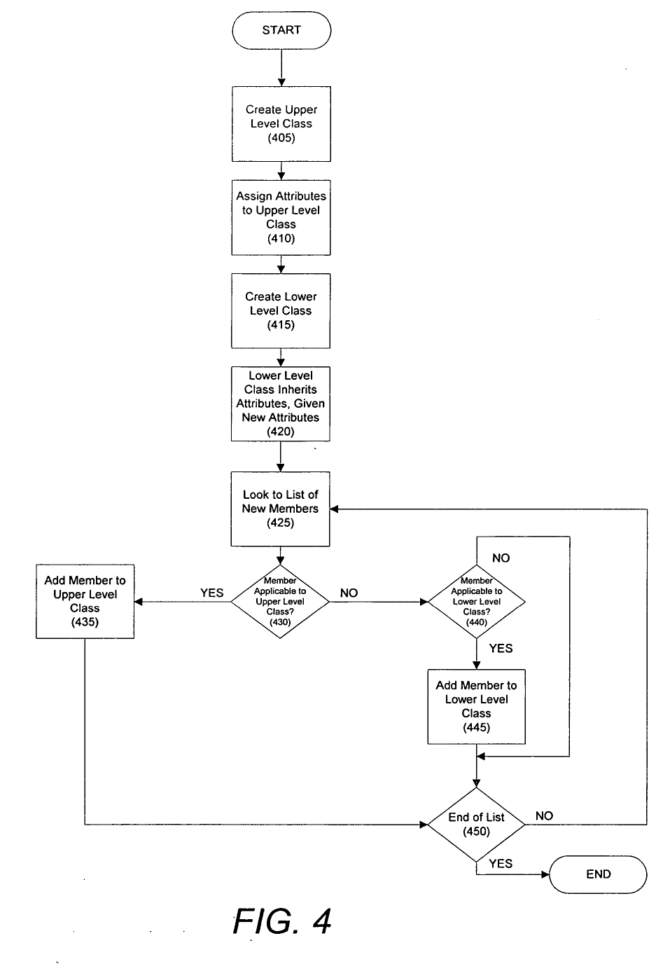

FIG. 4 is a flowchart illustrating setting a class hierarchy architecture and assigning members to the classes. FIG. 4 illustrates operations with regards to an upper level class and a lower level class. However, embodiments of the invention allow for the addition of classes below the lower level class. Classes can be added to horizontally extend class levels; as well. Step 405 creates an upper level class. Certain attributes are assigned to the upper level class in step 410. The assigned attributes in the upper level class are attributes that will describe members of the upper level classes and classes below the upper level class. Step 415 creates a lower level class. In step 420 the lower level class inherits the attributes that were assigned to the upper level class and certain more definitive attributes are added to the lower level class. Step 425 looks at a list of members. The list of members is not in any particular order. A decision is made in step 430 as to whether a particular member is applicable to the upper level class. If the member is applicable to the upper level class, step 435 adds the member to the upper level class. Once the member is added in step 425, step 450 determines if the end of the member list is completed. If the end of the list is not reached, the process goes back to step 425 and the member list. If a determination in step 430 is that the member does not belong to the upper level class, a determination is made in step 440 as to whether the member applies to the lower level class. If the member applies to the lower level class, the member is added in step 445. If the member is not applicable to either the upper level class or the lower level class, step 450 is performed to determine if the end of the list is reached. After the member is added to the lower level class in step 445, step 450 is performed to determine if the end of the member list is reached.

An Example Computing and Network Environment

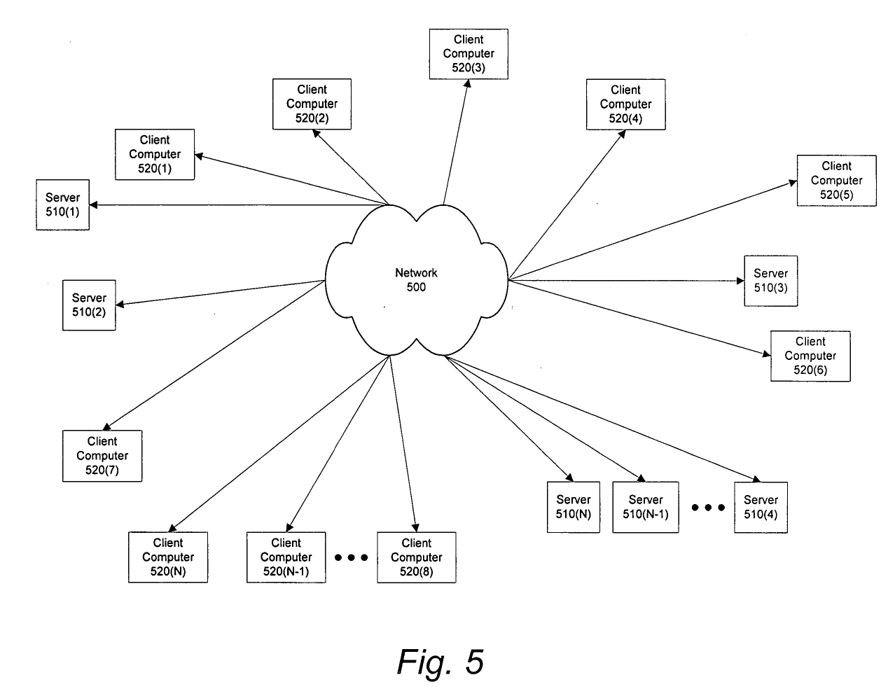

FIG. 5 is a block diagram illustrating a network environment in which a system according to the present invention may be practiced. As is illustrated in FIG. 5, network 500, such as a private wide area network (WAN) or the Internet, includes a number of networked servers 510(1)-(N) that are accessible by client computers 520(1)-(N). Communication between client computers 520(1)-(N) and servers 510(1)-(N) typically occurs over a publicly accessible network, such as a public switched telephone network (PSTN), a DSL connection, a cable modem connection or large bandwidth trunks (e.g., communications channels providing T1 or OC3 service). Client computers 520(1)-(N) access servers 510(1)-(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of client computers 520(1)-(N).

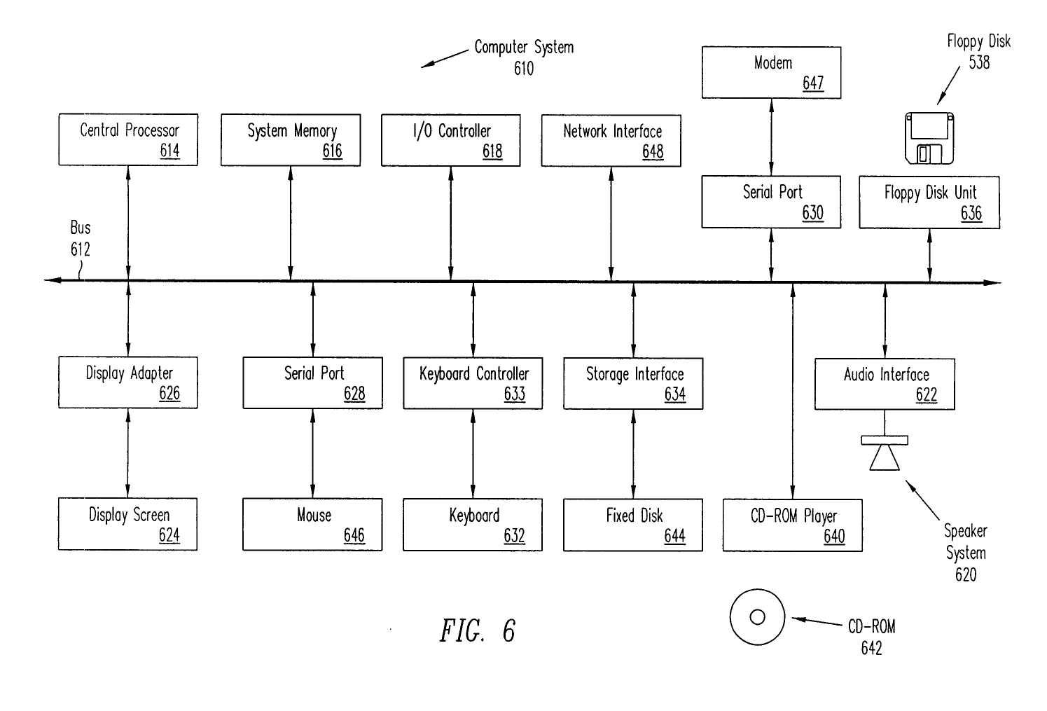

One or more of client computers 520(1)-(N) and/or one or more of servers 510(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 520(1)-(N) is shown in detail in FIG. 6.

FIG. 6 depicts a block diagram of a computer system 610 suitable for implementing the present invention, and example of one or more of client computers 520(1)-(N). Computer system 610 includes a bus 612 which interconnects major subsystems of computer system 610 such as a central processor 614, a system memory 616 (typically RAM, but which may also include ROM, flash RAM, or the like), an input/output controller 618, an external audio device such as a speaker system 620 via an audio output interface 622, an external device such as a display screen 624 via display adapter 626, serial ports 628 and 630, a keyboard 632 (interfaced with a keyboard controller 633), a storage interface 634, a floppy disk drive 636 operative to receive a floppy disk 638, and a CD-ROM drive 640 operative to receive a CD-ROM 642. Also included are a mouse 646 (or other point-and-click device, coupled to bus 612 via serial port 628), a modem 647 (coupled to bus 612 via serial port 630) and a network interface 648 (coupled directly to bus 612).

Bus 612 allows data communication between central processor 614 and system memory 616, which may include both read only memory (ROM) or flash memory (neither shown), and random access memory (RAM) (not shown), as previously noted. The RAM is generally the main memory into which the operating system and application programs are loaded and typically affords at least 66 megabytes of memory space. The ROM or flash memory may contain, among other code, the Basic Input-Output system (BIOS) which controls basic hardware operation such as the interaction with peripheral components. Applications resident with computer system 610 are generally stored on and accessed via a computer readable medium, such as a hard disk drive (e.g., fixed disk 644), an optical drive (e.g., CD-ROM drive 640), floppy disk unit 636 or other storage medium. Additionally, applications may be in the form of electronic signals modulated in accordance with the application and data communication technology when accessed via network modem 647 or interface 648.

Storage interface 634, as with the other storage interfaces of computer system 610, may connect to a standard computer readable medium for storage and/or retrieval of information, such as a fixed disk drive 644. Fixed disk drive 644 may be a part of computer system 610 or may be separate and accessed through other interface systems. Many other devices can be connected such as a mouse 646 connected to bus 612 via serial port 628, a modem 647 connected to bus 612 via serial port 630 and a network interface 648 connected directly to bus 612. Modem 647 may provide a direct connection to a remote server via a telephone link or to the Internet via an internet service provider (ISP). Network interface 648 may provide a direct connection to a remote server via a direct network link to the Internet via a POP (point of presence). Network interface 648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 6 to be present to practice the present invention. The devices and subsystems may be interconnected in different ways from that shown in FIG. 6. The operation of a computer system such as that shown in FIG. 6 is readily known in the art and is not discussed in detail in this application. Code to implement the present invention may be stored in computer-readable storage media such as one or more of system memory 616, fixed disk 644, CD-ROM 642, or floppy disk 638. Additionally, computer system 610 may be any kind of computing device, and so includes personal data assistants (PDAs), network appliance, X-window terminal or other such computing device. The operating system provided on computer system 610 may be MS-DOS®, MS-WINDOWS®, OS/2®, UNIX®, Linux® or other known operating system. Computer system 610 also supports a number of Internet access tools, including, for example, an HTTP-compliant web browser having a JavaScript interpreter, such as Netscape Navigator® 8.0, Microsoft Explorer® 8.0 and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 610). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

FIG. 7 is a block diagram depicting a network 700 in which computer system 610 is coupled to an internetwork 710, which is coupled, in turn, to client systems 720 and 730, as well as a server 740. Internetwork 710 (e.g., the Internet) is also capable of coupling client systems 720 and 730, and server 740 to one another. With reference to computer system 610, modem 647, network interface 648 or some other method can be used to provide connectivity from computer system 610 to internetwork 710. Computer system 610, client system 720 and client system 730 are able to access information on server 740 using, for example, a web browser (not shown). Such a web browser allows computer system 610, as well as client systems 720 and 730, to access data on server 740 representing the pages of a website hosted on server 740. Protocols for exchanging data via the Internet are well known to those skilled in the art. Although FIG. 7 depicts the use of the Internet for exchanging data, the present invention is not limited to the Internet or any particular network-based environment.

Referring to FIGS. 5, 6 and 7, a browser running on computer system 610 employs a TCP/IP connection to pass a request to server 740, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

Although the present invention has been described in connection with several embodiments, the invention is not intended to be limited to the specific forms set forth herein, but on the contrary, it is intended to cover such alternatives, modifications, and equivalents as can be reasonably included with in the scope of the invention as defined by the appended claims.

1-55. (canceled)

56. A computer-implemented method comprising:
associating an item with a class, wherein
the class comprises associated attributes that describe members of the class, and
said associating the item comprises selecting the class such that each associated attribute has a non-null value in describing the item;
storing a first record associating the item with the selected class; and
storing a second record associating the item with each associated attribute of the class and a value of the attribute describing the item.

57. The computer-implemented method of claim 56 wherein said selecting the class further comprises:
selecting the class from a class hierarchy, wherein the class hierarchy comprises child classes and associated parent classes, and a child class inherits each attribute of the associated parent class.

58. The computer-implemented method of claim 57 wherein the associated attributes of a child class further comprise an additional set of attributes not inherited from the associated parent class.

59. The computer-implemented method of claim 58 wherein said selecting the class further comprises:
determining a class in the hierarchy that has associated attributes necessary to describing the item.

60. The computer-implemented method of claim 56, wherein
said storing the first record is to a first memory structure, and
said storing the second record is to a second memory structure.

61. The computer-implemented method of claim 60 wherein the first and second memory structures are distinct from one another.

62. The computer-implemented method of claim 60 wherein the first and second memory structures are tables in a database.

63. The computer-implemented method of claim 56 wherein the associated attributes are metadata of the class.

64. An apparatus comprising:
means for associating an item with a class, wherein
the class comprises associated attributes that describe members of the class, and
said means for associating the item comprises means for selecting the class such that each associated attribute has a non-null value in describing the item;
means for storing a first record associating the item with the selected class; and
means for storing a second record associating the item with each associated attribute of the class and a value of the attribute describing the item.

65. The apparatus of claim 64 wherein said means for selecting the class further comprises:
means for selecting the class from a class hierarchy, wherein the class hierarchy comprises
child classes and associated parent classes, and
a child class inherits each attribute of the associated parent class.

66. The apparatus of claim 65 wherein the associated attributes of a child class further comprise an additional set of attributes not inherited from the associated parent class.

67. The apparatus of claim 66 wherein said means for selecting the class further comprises:
means for determining a class in the hierarchy that has associated attributes necessary to describing the item.

68. The apparatus of claim 64 further comprising:
a first and a second memory structure, wherein
said means for storing the first record performs said storing to the first memory structure, and
said means for storing the second record performs said storing to the second memory structure.

69. The apparatus of claim 68 wherein the first and second memory structures are distinct from one another.

70. The apparatus of claim 68 wherein the first and second memory structures are tables in a database.

71. The apparatus of claim 64 wherein the associated attributes are metadata of the class.

72. A system comprising:
a processor;
a memory, coupled to the processor, storing instructions executable on the processor to
associate an item with a class, wherein
the class comprises associated attributes that describe members of the class, and
the instructions to associate the item further comprise instructions to select the class such that each associated attribute has a non-null value in describing the item;
store a first record associating the item with the selected class; and
store a second record associating the item with each associated attribute of the class and a value of the attribute describing the item.

73. The system of claim 72 wherein the instructions to select the class further comprise instructions executable on the processor to:
select the class from a class hierarchy, wherein the class hierarchy comprises child classes and associated parent classes, and a child class inherits each attribute of the associated parent class.

74. The system of claim 73 wherein the associated attributes of a child class further comprise an additional set of attributes not inherited from the associated parent class.

75. The system of claim 74 wherein the instructions to selecting the class further comprise instructions executable on the processor to:
determine a class in the hierarchy that has associated attributes necessary to describing the item.

76. The system of claim 72 further comprising:
a first and a second memory structure;
the instructions to store the first record perform the storing to the first memory structure, and
the instructions to store the second record perform the storing to the second memory structure.

77. The system of claim 76 wherein the first and second memory structures are distinct from one another.

78. The system of claim 76 wherein the first and second memory structures are tables in a database.

79. The system of claim 72 wherein the associated attributes are metadata of the class.

80. A computer-readable storage medium comprising:
a first set of instructions, executable on a processor, configured to associate an item with a class, wherein
the class comprises associated attributes that describe members of the class, and
said first set of instructions further comprises a second set of instructions, executable on the processor, configured to select the class such that each associated attribute has a non-null value in describing the item;
a third set of instructions, executable on the processor, configured to store a first record associating the item with the selected class; and
a fourth set of instructions, executable on the processor, configured to store a second record associating the item with each associated attribute of the class and a value of the attribute describing the item.

81. The computer-readable storage medium of claim 80 wherein the second set of instructions further comprises:
a fifth set of instructions, executable on the processor, configured to select the class from a class hierarchy, wherein the class hierarchy comprises child classes and associated parent classes, and a child class inherits each attribute of the associated parent class.

82. The computer-readable storage medium of claim 81 wherein the associated attributes of a child class further comprise an additional set of attributes not inherited from the associated parent class.

83. The computer-readable storage medium of claim 82 wherein the fifth set of instructions further comprises:
a sixth set of instructions, executable on the processor, configured to determine a class in the hierarchy that has associated attributes necessary to describing the item.

84. The computer-readable storage medium of claim 80, wherein
the third set of instructions is further configured to perform said storing the first record to a first memory structure, and
the fourth set of instructions is further configured to perform said storing the second record to a second memory structure.

85. The computer-readable storage medium of claim 84 wherein the first and second memory structures are distinct from one another.

86. The computer-readable storage medium of claim 84 wherein the first and second memory structures are tables in a database.

87. The computer-readable storage medium of claim 80 wherein the associated attributes are metadata of the class.
